(19) United States
(12) Patent Application Publication
(10) Pub. No.: US 2014/0081922 A1
(43) Pub. Date: Mar. 20, 2014

(54) NAVIGATION DEVICE DATABASE UPDATE SYSTEM

(71) Applicant: Harman Becker Automotive Systems GmbH, Karlsbad (DE)

(72) Inventors: Peter Kunath, Munich (DE); Juergen Welscher, Markt Schwaben (DE); Viktor Samokhin, Munich (DE); Andreas Prinz, Munich (DE)

(73) Assignee: Harman Becker Automotive Systems GmbH, Karlsbad (DE)

(21) Appl. No.: 14/022,856

(22) Filed: Sep. 10, 2013

(30) Foreign Application Priority Data
Sep. 14, 2012 (EP) 12 184 530.9

(51) Int. Cl. G06F 17/30

(52) U.S. Cl. CPC G06F 17/30289
USPC 707/679

(57) ABSTRACT

A difference file which indicates a difference between a second relational database and a first relational database may be transferred to a navigation device. The navigation device may store a first compressed database version of the first relational database. The navigation device may restore database pages of the second relational database based on the first compressed database version and the difference file. The restoration may be performed on per-page level. The restoration may involve reading and uncompressing a database page from the first compressed database version, and modifying the uncompressed database page in accordance with the difference file. The modified database page, which may correspond to a restored page of the second relational database, may be compressed and appended to a target database.

### PRIORITY CLAIM

This application claims the benefit of priority from European Patent Application No. 12 184 530.9, filed Sep. 14, 2012, which is incorporated by reference.

### BACKGROUND OF THE INVENTION

1. Technical Field

The present disclosure relates to a database of a navigation device, and in particular, to updating the database.

2. Related Art

Navigation devices perform functions such as route searches between two locations. Navigation devices also may provide additional functionalities, such as serving as a travel guide which outputs, upon demand, information on points of interest (POI). Navigation devices also may provide additional driver assist functions, such as Advanced Driver Assist System functions. The navigation devices may rely on databases to provide such functionality.

### SUMMARY

According to exemplary embodiments, methods and devices are provided for a navigation device database update system to update a database of a navigation device. The system of embodiments may use a difference file which defines a difference between a second relational database and a first relational database. The first relational database may be stored on the navigation device in a compressed form as a first compressed database version. The difference file may be determined as difference between the (uncompressed) first relational database and the (uncompressed) second relational database. This may allow a size of the difference file to be reduced compared to cases where the difference file is computed as difference between compressed first and second database versions. Further, the same difference file may be used to update databases in different navigation devices, even when the different navigation devices use different compression algorithms for storing compressed database versions.

The database may be updated using a page-based procedure. The difference file may include entries which are organized in accordance with the database pages. The difference file may be applied to database pages of the first relational database, to restore database pages of the second relational database at the navigation device. For such an update, which may act directly on binary information in the database pages, the RDBSM may not be invoked to execute insert, update or delete statements. Such an update which may be performed on page level and which may act on the binary information in the database file may be universal in the sense that it may be applied independently of the internal structure of the database. By performing the update procedure on a page level, the update procedure can also be interrupted and continued at a later stage. This may be desirable when a vehicle in which the navigation device is installed is in operation for a time period that is shorter than the time period to complete the update by the navigation device. An overhead time for reading and uncompressing database pages at the navigation device may be mitigated to a certain degree. In addition or alternatively, the risk of fragmentation of the database may be mitigated. The computation of the difference file by a server may also be performed in a page-based manner. For example, the difference file may be computed by sequentially reading the database pages of the second, i.e. new, relational database and scanning for repeating byte patterns in the read database pages. The database pages may be uncompressed in addition to being read.

According to an embodiment, the system may perform a method of updating a database of a navigation device is provided. The method can include computing, by a server, a difference file which indicates a difference between a second relational database and a first relational database. The first and second relational databases respectively may have a plurality of database pages. The difference file may be received at the navigation device, which may store a first compressed database version of the first relational database. The navigation device may restore the database pages of the second relational database from the first compressed database version and the difference file. The restoration may be performed on a page level and may include reading and uncompressing a database page from the first compressed database version. The restoration may further include modifying the uncompressed database page in accordance with the difference file to restore a database page of the second relational database and appending the database page of the second relational database to a target database. The restoration may be repeated iteratively for all database pages, until the second relational database or a compressed version thereof is completely restored.

According to an embodiment, the system includes a navigation device. The navigation device may include a storage device which may store a first compressed database version of a first relational database. The first relational database may include multiple database pages. The navigation device may further include an interface configured to receive a difference file indicating a difference between a second relational database and the first relational database. The navigation device may further include a processing device, or processor, coupled to the storage device and the interface. The processor may direct performance of a restoration procedure to restore database pages of the second relational database from the first compressed database version and the difference file. To control performance of the restoration procedure, the processor may read and uncompress a database page from the first compressed database version, and modify the uncompressed database page in accordance with the difference file to restore a database page of the second relational database. The processor may further append the restored database page of the second relational database to a target database. The processor may restore the database pages iteratively, until the second relational database or a compressed version of the second relational database is completely restored.

In an embodiment, the system includes an update server. The update server may include a storage device which may store a first compressed database version of a first relational database and a second compressed database version of a second relational database. The first and second relational databases may each have a plurality of database pages. The update server may further include a processing device, or processor, configured to uncompress the first compressed database version to obtain the database pages of the first relational database. The processor may also direct the second compressed database version to be uncompressed in order to obtain the database pages of the second relational database. Further, the processor may compute a difference file which defines a difference between the database pages of the second relational database and the database pages of the first relational database. The update server may further include an interface to output the difference file to transfer the difference file to a navigation device.

According to an embodiment, the system may include both the navigation device and the update server.

It is to be understood that the features mentioned above and those to be explained below can be used not only in the respective combinations indicated, but also in other combinations or in isolation.

Other systems, methods, features and advantages will be, or will become, apparent to one with skill in the art upon examination of the following figures and detailed description. It is intended that all such additional systems, methods, features and advantages be included within this description, be within the scope of the invention, and be protected by the following claims.

### BRIEF DESCRIPTION OF THE DRAWINGS

The system may be better understood with reference to the following drawings and description. The components in the figures are not necessarily to scale, emphasis instead being placed upon illustrating the principles of the invention. Moreover, in the figures, like referenced numerals designate corresponding parts throughout the different views.

FIG. 1 is a schematic diagram of an example system which includes a navigation device and an update server according to an embodiment.

FIG. 2 is a schematic block representation of an example navigation device.

FIG. 3 is a flowchart of an example operation performed by an example server according to an embodiment.

FIG. 4 is a flowchart of an example operation performed by a navigation device according to an embodiment.

FIG. 5 illustrates examples of first and second compressed database versions.

FIG. 6 illustrates examples of association of first and second relational databases with uncompressed database pages which are used for generating a difference file.

FIG. 7 illustrates an example of generation of a difference file.

FIG. 8 illustrates an example of data in a storage device before restoration of database pages has begun.

FIG. 9 illustrates an example of data in a storage device during restoration of database pages.

FIG. 10 illustrate an example snapshot of data in a storage device after restoration of database pages is complete.

### DETAILED DESCRIPTION OF THE PREFERRED EMBODIMENTS

Embodiments of the invention will be described with reference to the drawings in which like numerals refer to like elements. While embodiments will be described in specific contexts, such as vehicle navigation devices, embodiments may also be used in other contexts, such as portable navigation devices. While specific implementations and structures of relational databases are illustrated in the drawings and will be referred to below, other implementations may be used in other embodiments. For illustration, a relational database may be stored in plural files, e.g. one file which includes the header and another file which includes the database pages of the relational database. The features of embodiments may be combined with each other unless specifically stated otherwise.

To reflect recent changes in road networks, a database stored in a navigation device may be updated. It may be generally desired to keep data transfer volumes moderate during an update. To this end, techniques which use “differential” or “delta” updates may be employed. In an example technique, a full new database may not be transferred. A “difference file” (also referred to as “delta file”) may be transferred and a new database may be computed using the difference file. In another example a tiling technique may be used in which an area may be subdivided into plural tiles, with the update being performed selectively only for certain tiles.

Various approaches may be used to perform database updates by generating a difference file and processing the difference file at the navigation device. For example, in one approach, an integrated database manager of a database may be used. A difference file may include a sequence of functions performed by the database manager. For example, for a database which is a relational database, the relational database management system (RDBMS) may be configured to execute a sequence of insert, update or delete statements. The sequence of such statements may be written into the difference file. This may lead to undesired fragmentation of the resulting database. In fragmentation, data that was originally stored in one storage area, based on being associated to a particular geographical or other context, may be separated during update.

To keep storage space requirements moderate, relational databases may be stored in a compressed format in a navigation device. A first database stored in such a compressed format may be referred to as a “first compressed database version”, for example. The compression may be performed by the RDBMS. An uncompressed version of the first database may be referred to as a “first relational database”, for example, it being understood that reference is made to the uncompressed version of the first database and uncompressed database pages of the first database. A delta update may be performed directly on compressed database versions. Data transfer volumes may still be fairly large. Data transfer times may depend on the data transfer volumes. Further, different navigation devices may use different compression techniques. Therefore, different difference files may be computed for the different navigation devices.

An example system to update a navigation database may update the database on a page-based procedure. A “database page” refers to an internal structure to organize data in one or several database file(s). The database page should not be confused with a hard disk page. The database page of a relational database may have a size which may be set to any one of various discrete values. When the relational database is stored in compressed format, i.e. as a compressed database version, the database pages of the relational database may have different sizes. According to embodiments, a difference file may be computed at a server. The server may read the database pages from a second compressed database version. The server may uncompress the database pages before or after reading the database pages. The server may also perform a pattern scan to identify matching patterns in the database pages which are read and, if required, uncompressed from a first compressed database version. The difference file or “delta” between the (uncompressed) database pages of a first relational database and (uncompressed) database pages of a second relational database may be determined. The difference file may be transferred to a navigation device which stores the first compressed database version. The difference file may be used to patch, or selectively update, the first compressed database version, thereby generating the second compressed database version as a new database at the navigation device. The navigation device may thus restore database pages of the second relational database at a page level, by sequentially reading and uncompressing the database pages from the first compressed database version and patching the database pages using the difference file. The restored uncompressed database pages of the second relational database may be directly appended to a destination database. Alternately, or in addition, the restored uncompressed database pages of the second relational database may be stored and then appended to the destination database. The restored uncompressed database pages may further be compressed before appending to the destination database.

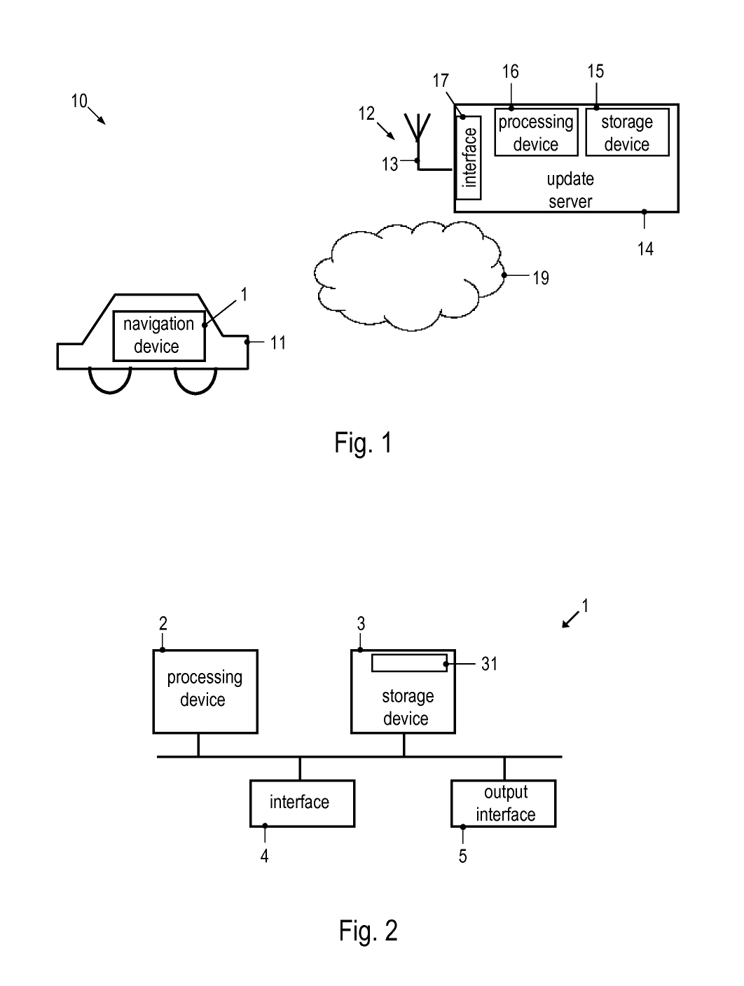

FIG. 1 is a schematic illustration of an example of a vehicle 11, a download center 12, and a communication network 19. The vehicle 11 may include a navigation device 1. At least one of the download center 12 and the navigation device 1 may operate within an example navigation device database update system 10. The navigation device 1 may be configured for wireless communication with the download center 12 via the communication network 19. While only one navigation device 1 is illustrated, multiple vehicles respectively having a navigation device, may communicate with the download center 12. The difference file may be transferred to the navigation device 1 from the download center 12 via the communication network 19. Alternatively, or in addition, the difference file may be transferred to the navigation device 1 using a physical storage medium. In the case of transfer using a physical storage medium, the communication network 19 may not be used.

The navigation device 1 may include a database storing the first compressed database version. The first compressed database version may be the old database which is to be updated to a new database. The first compressed database version may be obtained by compressing the first relational database, using the RDBMS of the first database, for example.

The download center 12 may include a transceiver 13 and an update server 14. The update server 14 may generate the difference file. The update server 14 may include a storage device 15, a processing device 16, and an interface 17. The storage device 15 in turn may include information used for computing the difference file. The storage device 15 may also store the first compressed database version and the second compressed database version. The first and second compressed database versions may also be obtained by applying a lightweight compression to the first and second relational databases, respectively. The lightweight compression may be performed by the RDBMS of the respective database. Alternatively, the storage device 15 of the update server 14 may store one or both of the first and second relational databases in uncompressed format. The storage device 15 may be a volatile memory and/or non-volatile memory or a cache memory such as a random access memory (RAM), or flash memory. Alternatively or in addition, the storage device 15 may include an optical, magnetic (hard-drive) or any other form of data storage device. Accordingly, the storage device 15 may be a non-transitory computer readable storage medium.

The processing device 16 of the update server 14 may compute the difference file by reading and, if required, uncompressing database pages from the second compressed database version. The processing device 16 may also perform a pattern scan to identify differences between the database pages of the different versions, for example between the database pages of the first relational database and the second relational database. The processing device 16 may be a microprocessor, a digital signal processor, a graphics processing unit, or any other processing unit capable of executing computer readable instructions. The processing device 16 may be an x86 based processor or an ARM based processor or may employ any other processor architecture. The processing device 16 may be a single core or a multi-core processor. The processing device 16 may be a serial processor or a parallel processor. Further, the processing device 16 may be referred to as a processor.

The difference file may be output via the interface 17 and may be transmitted via the transceiver 13. The transceiver 13 may operate on a wireless network such as the communication network 19. The transceiver 13 and the communication network 19 may use one or more cellular or non-cellular wireless communication technology, such as LTE, WLAN or similar to transfer the difference file. In other examples, the difference file may be transferred to the navigation device 1 using a storage medium as physical transfer medium such as a portable hard drive or a universal serial bus (USB) drive.

The navigation device 1 may receive the difference file. The navigation device 1 may update the database on the page level of the database pages. The navigation device 1 may sequentially read and uncompress the database pages from the first compressed database version which is stored locally at the navigation device 1. These uncompressed database pages may represent the database pages of the first relational database. The navigation device 1 may modify the database pages of the first relational database in accordance with instructions included in the difference file. Thereby, the database pages of the second relational database may be restored at the navigation device 1. The navigation device 1 may append the modified database pages that represent the database pages of the second relational database to a target database. The modified database pages may be uncompressed, or may be compressed before appending to the target database. The second compressed database version may be restored page by page at the navigation device 1 in an iterative process. The navigation device 1 may interrupt the restoration of the database pages of the second relational database. For example when the navigation device 1 enters a low power mode, the restoration may be paused. When the navigation device 1 powers up again, the restoration of the database pages may be continued from where it was interrupted. The navigation device 1 may, thus, continue the restoration with a database page that is next in sequential order after a database page restored immediately before the interruption.

FIG. 2 is a schematic block diagram representation of an example navigation device 1. The navigation device 1 may be installed in a vehicle and may be configured to receive the difference file which is transferred from the update server 14 as discussed with reference to FIG. 1.

The navigation device 1 may include a processing device 2, a storage device 3, an interface 4, and an output interface 5. The processing device 2 may control operation of the navigation device 1. The processing device 2 may control operation of the navigation device 1 according to control instructions stored in the storage device 3. The processing device 2 may be a central processing unit, for example in the form of one or more microprocessors, digital signal processors or application-specific integrated circuits. The processing device 2 may further be a graphics processing unit, or any other processing unit capable of executing computer readable instructions. The processing device 2 may be an x86 based processor or an ARM based processor or may employ any other processor architecture. The processing device 2 may be a single core or a multi-core processor. The processing device 2 may be a serial processor or a parallel processor. Further, the processing device 2 may be referred to as a processor.

The storage device 3 may store the first compressed database version 31. The first compressed database version 31 may be obtained by applying compression, such as a lightweight compression, to the first relational database. The lightweight compression may be performed by the RDBMS of the first relational database. The storage device 3 may include any one, or any combination, of various types of storage or memory media, such as random access memory, flash memory, a hard disk drive, removable memories such as a compact disk (CD), a DVD, a memory card or the like. The storage device 3 may be a volatile memory and/or non-volatile memory or a cache memory such as a random access memory (RAM), or flash memory. Accordingly, the storage device 15 may be a non-transitory computer readable storage medium.

The input interface 4 may be or may include a wireless transceiver or a connector for a removable storage medium, such as a USB memory. The processing device 2 may receive the difference file from the interface 4.

The output interface 5 may provide information to a user. The output interface 5 may include an optical output device, such as to drive a display, an audio output device, such as to drive a loudspeaker, and/or any other form of user interface to the system.

The navigation device 1 may include additional components, such as a user input interface and/or position sensor and/or a vehicle interface. The user input interface may be configured to allow the user to input textual or voice information. The position sensor may determine a current position of the vehicle 11 in which the navigation device 1 is installed. The position sensor may comprise a Global Positioning System (GPS) sensor, a Galileo sensor, a position sensor based on mobile telecommunication networks and the like. The vehicle interface may allow the processing device 2 to obtain information from other vehicle systems or vehicle status information. The vehicle interface may, for example, comprise a controller area network (CAN) or a Media Oriented devices Transport (MOST) interface.

Steps that may be followed for updating the database of the navigation device 1 from the first compressed database version 31 to the second compressed database version may be performed by the update server 14 and/or the navigation device 1 of the system 10. The update may be performed on a per page basis, in which a database page of the second relational database may be restored using the difference file and a database page which is read and uncompressed from the first compressed database file. The difference file which is used for patching the database pages defines differences in terms of binary information in the database pages of the first and second relational databases. The difference file may be used for patching the database pages at the navigation device 1, without requiring any information on the internal structure of the database 31 or without having to invoke the RDBMS for executing insert, update or delete statements.

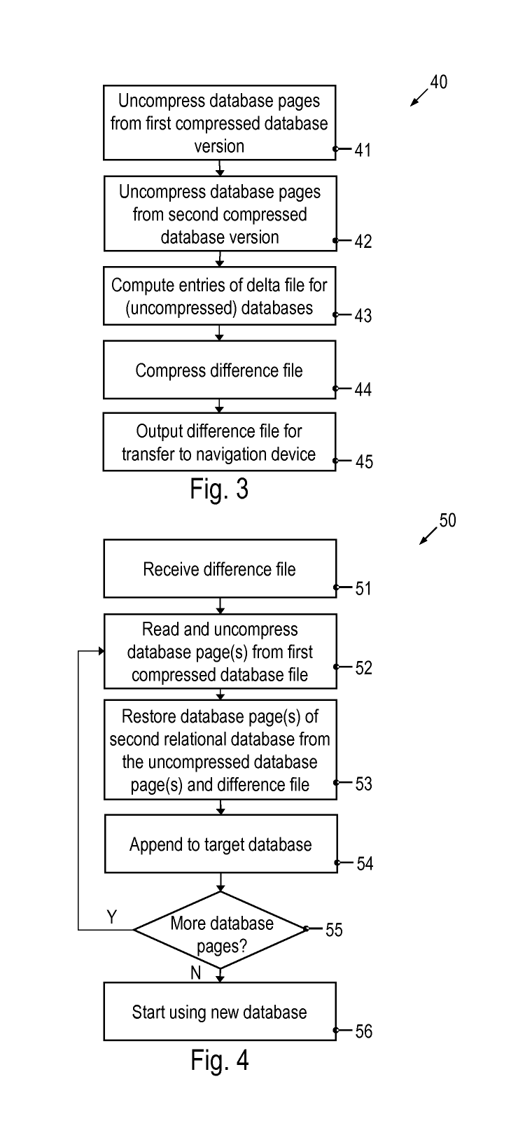

FIG. 3 illustrates a flowchart of an example update procedure 40. The steps illustrated in the procedure 40 may be performed for generating the difference file using the update server 14. The update server 14 may compute the difference file which defines the differences between a second relational database and a first relational database. The update server 14 may store the first relational database in compressed format as the first compressed database version. The update server 14 may also store the second relational database in compressed format as the second compressed database version. In addition or alternately, the update server 14 may store uncompressed relational databases, in which case the compression/uncompression related steps illustrated in FIG. 3 may be omitted.

At step 41, the database pages may be read and uncompressed from the first compressed database version. At step 42, the database pages may be read and uncompressed from the second compressed database version. Reading and uncompressing may be performed sequentially for one or a few database pages at a time.

At step 43, entries of the difference file may be computed. The entries of the difference file may indicate changes in the information, such as binary information, of the database pages of the (uncompressed) second relational database and the binary information of the database pages of the (uncompressed) first relational database. To compute the entries of the difference file, one or more pattern scanners may be executed. A pattern scanner may identify substantially identical data patterns, such as similar patterns of binary information, in different database pages or within the same database page. A data pattern may be a bit or a byte pattern. A first pattern scanner may be executed to determine, for a data pattern in the database pages of the second relational database, whether the same or a similar data pattern is contained in the database pages of the first relational databases. If the database pages store road network data for areas in which the road network has not undergone any changes, or other data which has not undergone any change, the first pattern scanner may identify a matching pattern in the database pages of the first and second relational databases.

Optionally, or in addition, a second pattern scanner may also be executed. The second pattern scanner may determine, for the data pattern in the database page of the second relational database, whether the same data pattern is included elsewhere in the current database page of the second relational database. The second pattern scanner may further determine if the data pattern is included in a preceding database page of the second relational database. If any of the first pattern scanner or the second pattern scanner identifies a matching pattern, a reference to the matching data pattern may be written into the difference file. Only when no matching pattern is identified, the respective bit or byte data pattern itself may be written into the difference file.

At step 44, the difference file may optionally be compressed for transferring it to the navigation device 1. Various compression tools, such as a binary diff (bdiff) compression tool, may be used to compress the difference file. It will be appreciated that, while the difference file may optionally be compressed for transferring to the navigation device 1, the difference file itself may be determined as a difference between the (uncompressed) first and second relational databases.

At step 45, the difference file may be output via the interface 13 for transferring it to the navigation device 1.

The sequence of steps 41 to 44 may be repeated several times, with one or several database pages of the second relational database being respectively read at a time to compute the associated entries in the difference file.

Since the determination of the difference file may be performed on page level, so as to identify differences between the binary information in files, no knowledge of the underlying structure of the first and second relational databases may be required with the exception of database page format information, such as lengths and/or offsets of the database pages. The database page format information may, for example, be directly determined from a header of the respective database. Various modifications of the procedure 40 may be used in other embodiments. In an example, the first and second relational databases may be stored at the update server 14 in uncompressed format. In this case, the update server 14 may not uncompress the read database pages.

While the determination of the difference file is performed on page level by identifying differences between the binary information of database pages, the difference file may define the difference between the first relational database having a plurality of pages and the second relational database having a plurality of pages.

The difference file may be a patch, or selective updates, obtained by determining differences between the first and second relational databases, combined in one difference file. As used herein, the term “patch” refers to updated data that is stored in existing pages of a database to overwrite previously stored data in the respective pages that corresponds to the new data, such that only corresponding parts of the existing database pages in the database are overwritten. The difference file may include the differences for multiple database pages, all combined or packed into one difference file. In this manner, the difference file may be generated such that it includes information for updating multiple database pages, in particular all database pages, of the database 31 stored at the navigation device 1, possibly in compressed format.

A versioning scheme on the page level may or may not be used to generate the difference file. The difference file may be generated from the first and second database relational databases in the manner described with reference to FIG. 3.

FIG. 4 illustrates a flowchart of an example procedure 50. The steps of procedure 50 may be performed for restoring the database pages of the second compressed database version at the navigation device 1. The procedure 50 may involve restoring database pages of the second relational database by using the difference file to patch the database pages of the first compressed database version. The first compressed database version may be initially stored in the navigation device 1. While the navigation device 1 performs the steps to update the first compressed database version, navigation tasks may still be performed in parallel based on the first compressed database version that does not include the patch.

At step 51, the difference file may be received by the navigation device 1. In case the received difference file is compressed before the transfer to the navigation device 1, the difference file may be uncompressed by the navigation device 1.

At step 52, one or several database pages may be read and uncompressed from the first compressed database version which may be stored in the navigation device 1. Reading and uncompressing may be performed sequentially for only a pre-defined number of database pages at a time. For example, only one or only a few database pages may be read and uncompressed at a time. This may ensure that the navigation device 1 may complete operations involved in the restoration or update within a short time. Further, this may allow the navigation device 1 to interrupt the restoration. Further yet, storage space overhead at the navigation device 1 used during the update may be efficiently minimized, or kept moderate, because the full (uncompressed) first relational database may not be stored.

At step 53, one or several database pages of the second relational database may be restored based on the difference file and the database pages which were read and uncompressed from the first compressed database version. “Restoring” may refer to generation or reconstruction of the database pages of the second relational database, i.e. the new database that is stored on the update server 14, from the first, i.e. old, compressed database version and the difference file. The restoring may be performed at the navigation device 1. The restoring at step 53 may include modifying the database pages which were read and uncompressed from the first compressed database version in accordance with the difference file, to thereby restore database pages of the second relational database. If the difference file includes a reference to a data pattern, such as a bit or a byte pattern, in any database page of the first relational database, the data pattern may be copied from the corresponding database page of the first relational database to the restored database page of the second relational database. If the difference file includes a reference to a data pattern in a database page of the second relational database that was previously restored or in the current database page that is being restored, the data pattern may be copied from the corresponding database page of the second relational database. If the difference file includes a data pattern for which the pattern scanner did not identify any matches, the data pattern may be copied from the difference file to the restored database page of the second relational database.

At step 54, the restored database pages of the second relational database may be compressed and appended to a target database.

At step 55, it may be determined whether there are more database pages for which steps 52-54 are to be executed. In this case, the method may return to step 52. Otherwise, if all database pages of the second relational database were restored, the target database may correspond to the second compressed database version. At step 56, the navigation device 1 may start using the restored second compressed database version. The delta file and the first compressed database version may be deleted.

The page-based restoring procedure in the loop with steps 52-54 may be iteratively repeated, with one or a small number of database pages being processed in each iteration. The iterations may be continued until all database pages of the first relational database have been processed and all database pages of the second relational database have been restored. As previously mentioned, navigation tasks may still be performed based on the first relational database while the procedure 50 is being carried out. The first compressed database version may not be deleted until after the procedure 50 has been completed successfully.

Since the restoration may be performed on page level, it may be interrupted. In order to facilitate interruption of the restoration procedure, the target database may be stored persistently when the appending step 54 has been completed. Such an interruption may be triggered in response to the vehicle 11 in which the navigation device 1 is installed is parked or the navigation device 1 is powered off for other reasons. When the navigation device 1 starts up again, the restoration is continued for any remaining database pages.

Both, when generating the difference file and when using the difference file to restore the database pages of the second relational database, information on the offsets of database pages stored in the headers of the first and second relational databases may be used to read and process the database pages from the first and second compressed database versions.

The difference file, while being used for performing an update at page level, may be used for modifying several database pages of the first relational database to thereby restore database pages of the second relational database. The difference file may thus define a patch which is applied to several database pages, rather than defining a difference for just one database page.

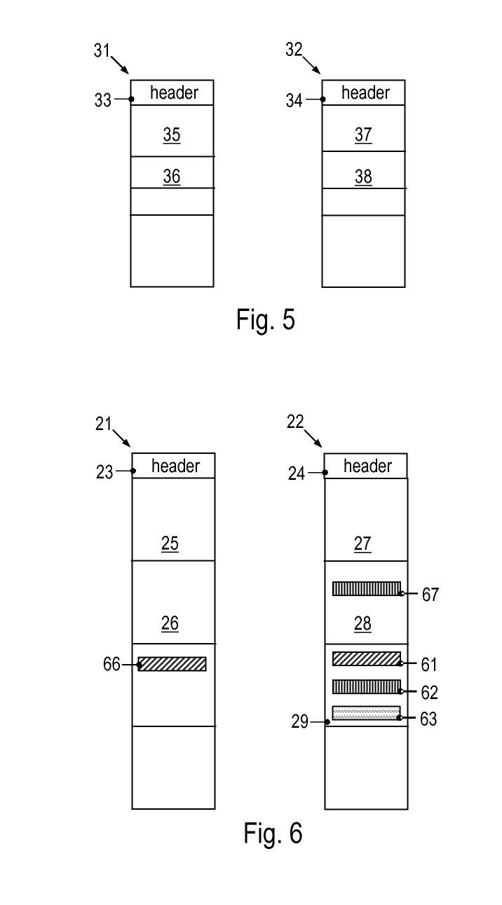

FIG. 5 schematically illustrates an example of a first compressed database version 31 and a second compressed database version 32. The first compressed database version 31 may include a header 33 and a plurality of compressed database pages 35, 36. The second compressed database version 32 may include a header 34 and a plurality of compressed database pages 37, 38. The sizes of the database pages may vary within the compressed database versions 31, 32. The first compressed database version 31 may be initially stored in the navigation device 1. After the update procedure, the second compressed database version 32 may be stored in the navigation device 1 and may be used for navigation purposes. The update server 14 may also store the compressed database versions 31, 32. Alternatively, another compression or no compression at all may be applied to the versions of the first and second relational databases stored at the update server.

FIG. 6 schematically illustrates an example first relational database 21 and an example second relational database 22. The first relational database 21 may include a header 23 and a plurality of database pages 25, 26. The database pages 25, 26 may be obtained by reading and uncompressing the database pages 35, 36 from the first compressed database version 31. The second relational database 22 may include a header 24 and a plurality of database pages 27, 28, 29. The database pages 27, 28 may be obtained by reading and uncompressing the database pages 37, 38 from the second compressed database version 32. The first relational database 21 may have a size greater than that of the first compressed database version 31. The second relational database 22 may have a size greater than that of the second compressed database version 32. While the individual database pages 25, 26 of the first relational database 21 may be retrieved by reading and uncompressing the database pages 35, 36 from the first compressed database version 31, all the database pages of the first relational database 21 may not be simultaneously stored at the navigation device 1 during an update procedure. The update procedure may be carried out for one database page after the other, or for small groups of database pages.

The difference file may be computed such that it indicates differences between the database pages of the (uncompressed) second relational database 22 and the (uncompressed) first relational database 21. For illustration, in case the database page 27 of the second relational database 22 is identical to the database page 25 of the first relational database 21, the difference file may only include a reference to the database page 25 of the first relational database. In the navigation device 1, the database page 27 may be restored by copying the database page 25, which may be obtained by reading and uncompressing the database page 35 from the first compressed database version 31.

When generating the difference file, at least one pattern scanner may identify matching patterns for data patterns in the database page 29 of the second relational database 22 which is currently being processed. The pattern scanner is hardware, or a combination of hardware and software. For example, the pattern scanner may include and/or initiate execution of an application specific integrated circuit (ASIC), a Field Programmable Gate Array (FPGA), a circuit, a digital logic circuit, an analog circuit, a combination of discrete circuits, gates, or any other type of hardware, or combination thereof. Accordingly, as used herein, execution of pattern scanner by a processor may also refer to logic based processing by the pattern scanner that is initiated directly or indirectly by a processor to complete a process or obtain a result. Alternatively or in addition, the pattern scanner may include memory hardware, such as at least a portion of a memory, for example, that includes instructions executable with a processor to implement one or more of the features of the pattern scanner. When the pattern scanner includes instructions stored in memory and executable with the processor 2 or processor 16, the pattern scanner may or may not include a processor. In some examples, the pattern scanner may include only memory storing instructions executable with the processor 2 or 16 to implement the features of the pattern scanner without the pattern scanner including any other hardware. Because the pattern scanner includes at least some hardware, even when the included hardware includes software, the pattern scanner may be interchangeably referred to as a hardware unit, such as the pattern scanner hardware unit.

A first pattern scanner may identify whether any of the database pages of the first relational database 21 includes a data pattern 61 found in the current database page 29. If the first pattern scanner determines that the data pattern 61 has a matching pattern 66 in a database page of the first relational database 21, a reference to the matching pattern 66 may be written into the difference file. A second pattern scanner may identify whether the current database page 29 or any one of a pre-determined number of database pages of the second relational database 21 that precede the current database page 29 includes a data pattern 62 found in the current database page 29. When the second pattern scanner determines that the data pattern 62 has a matching pattern 67 in the current database page 28 or in any one of the database pages of the second relational database 22 that precede the current database page 29, a reference to the matching pattern 67 may be written into the difference file. The number of the database pages of the second relational database 22 to be searched by the second pattern scanner may be a predetermined number. When both the first pattern scanner and the second pattern scanner identify a matching pattern, preference may be given to the matching pattern identified by the second pattern scanner. This may reduce processing times at the navigation device 1. If neither the first pattern scanner nor the second pattern scanner identifies a matching pattern for a data pattern 63, the data pattern 63 itself may be written into the difference file. The data pattern 63 may be a new binary pattern in a database page which may be transferred to the navigation device 1 in the difference file and which may not be copied from information already available at the navigation device 1.

When the second pattern scanner is used, a sliding search window may be defined in which the second pattern scanner looks for matching patterns. The sliding search window may include the current database page 29 and a pre-defined number of database pages of the second relational database 22 which directly precede the current database page 29. In another example, the second pattern scanner may be omitted and only the first pattern scanner may be used. The first pattern scanner may look for matching patterns in any database page of the first relational database 21. A random access may be performed for the first relational database 21. Alternatively or in addition, a sliding search window may also be used to define the search range of the first pattern scanner. The sliding search window of the first pattern scanner may be greater than the sliding search window of the second pattern scanner. The sliding search window of the first pattern scanner may be considered greater than the sliding search window of the second pattern scanner if the predefined number of database pages to scan associated with the first pattern scanner is greater than the predefined number of database pages associated with the second pattern scanner.

When the difference file is used for restoring database pages of the second relational database 22, a data pattern, which may be a binary pattern, may accordingly be copied into the database page 29 that is currently being restored. The data pattern may be copied from the database pages of the first relational database 21, if the first pattern scanner had identified a matching pattern 66. Alternately, the data pattern may be copied from a previously restored database page of the second relational database 22, if the second pattern scanner had identified a matching pattern 67. In yet another example, the data pattern may be copied from the difference file, if neither the first pattern scanner nor the second pattern scanner identified a matching pattern.

It will be appreciated that a database may be stored in a single file. Alternatively, a database may also be stored across multiple files. For illustration, the header may be stored in one file and the compressed or uncompressed database pages may be stored in a separate file. In this case, the procedures described herein may be carried out for at least one file of the database, e.g. for a file which stores the database pages.

Further, an example navigation device may store several separate database files. Each one of the separate database files may store database pages of a relational database. The computation of the difference file and the restoration procedure at the navigation device may then be performed for each database file. For processing reasons, such as ease of handling, when several difference files may be computed by the server for separate database files, the several difference files may be combined into a single difference file for transfer to the navigation device.

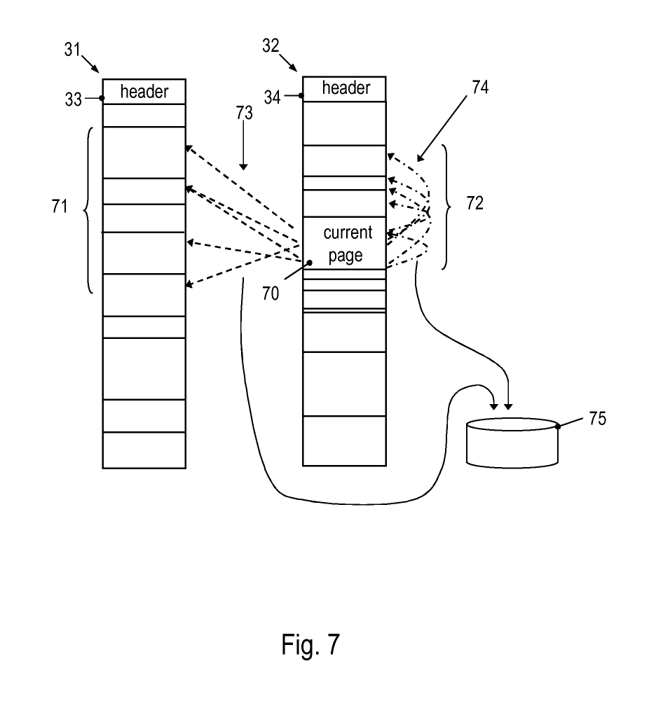

FIG. 7 illustrates an example of generation of a difference file. A database page 70 may be read and uncompressed from the second compressed database version 32. The first pattern scanner may identify matching patterns in the database pages of the first relational database 31 that are located within a first sliding search window 71. References to such matching patterns, schematically indicated by arrows 73, may be stored in the difference file 75. The second pattern scanner may identify matching patterns in the database pages of the second relational database that are located within a second sliding search window 72. References to such matching patterns, schematically indicated by arrows 74, may be stored in the difference file 75. The pattern matching of the first and second pattern scanner may be performed on the information, such as binary information, such that matching bit or byte patterns are identified. If neither the first pattern scanner nor the second pattern scanner identifies a matching pattern, the respective information, such as the bit or byte pattern, of the current page 70 may be written into the difference file 75.

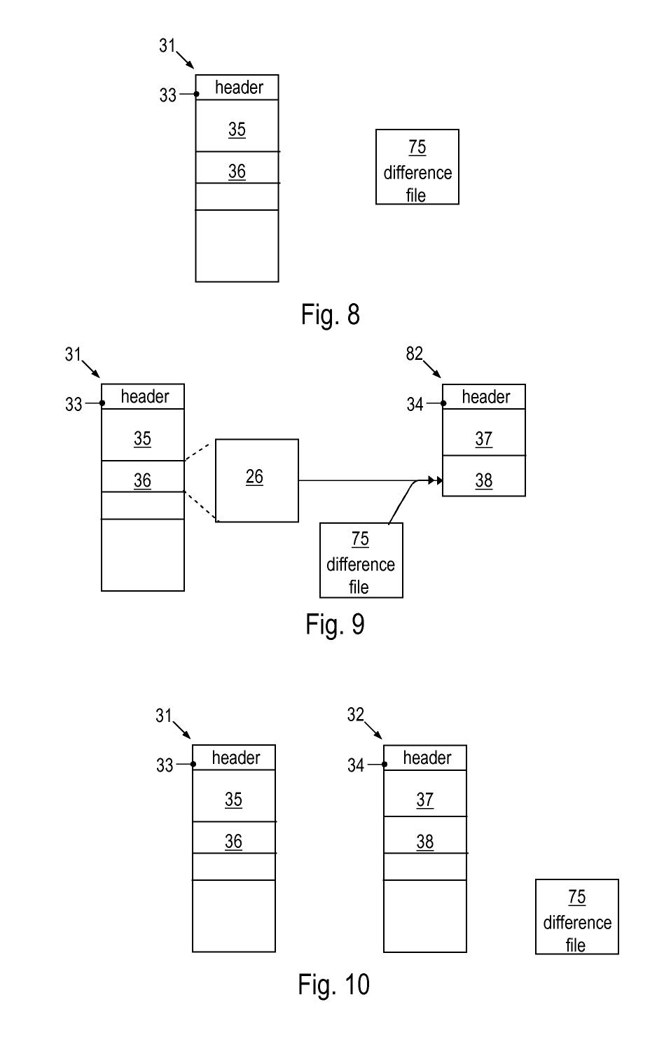

FIG. 8 illustrates an example of data stored in the storage device 3 of the navigation device 1. In an initial state, the navigation device 1 may store the first compressed database version 31. The difference file 75 may be received and stored at the navigation device 1. If the difference file 75 has been compressed for transfer to the navigation device 1, it may first be uncompressed.

FIG. 9 illustrates an example of data stored in the storage device 3 during a page-based restoration process. The header 34 of the second compressed database version 32 may be read from the difference file 75. A target database 82 may be generated which initially may include the header 34. By reading and uncompressing the database page 36 from the first compressed database version 31, the corresponding database page 26 of the first relational database 21 may be obtained. The database page 26 of the first relational database 21 may be modified in accordance with instructions included in the difference file 75. The difference file 75 may be used for patching the database page 26 of the first relational database 21, so as to generate a database page of the second relational database 22. After compression, the modified database page may be appended to the target database 82. The modified data page appended to the target database 82 may correspond to the database page 38 of the second compressed database version 32. This process may be repeated for all database pages.

FIG. 10 illustrates an example of data stored in the storage device 3 of the navigation device 1 at the end of the restoration process. The target database 82 may correspond to the second compressed database version 32. The difference file 75 and the first relational database version 31 may be deleted. Navigation tasks may be executed based on the second compressed database version 32.

While devices and methods of generating the difference file 75 according to some examples have been described in detail, modifications may be implemented in other examples. For example, while a specific implementation of determining the difference file 75 was described in detail, the difference file 75 may also be generated using a wide variety of other techniques. Further, other delta encoding tools may be applied to the database pages of the first and second relational databases.

In another example, a version of a digital map may include multiple components, stored as part of the database of the navigation device 1 and/or the update server 14. There may be components naming, for points of interests, for phonemes, for routing, for basic map display, for advanced map display, for guidance bitmaps, for advanced driver assist system (ADAS) functions, for travel guide functions, for metadata, and/or for any other components related to navigation. While these components may be combined in a database file in some implementations, in other implementations the components may also be provided as separate data sets. Alternatively or additionally, different geographical update regions may be defined. In this case, the procedures described herein may be used for each one of the different components or different update regions.

Embodiments of the invention may be used for maintaining a database of vehicle navigation devices.

While various embodiments of the invention have been described, it will be apparent to those of ordinary skill in the art that many more embodiments and implementations are possible within the scope of the invention. Accordingly, the invention is not to be restricted except in light of the attached claims and their equivalents.

We claim:

1. A method of updating a database of a navigation device, the method comprising:
computing, by a server, a difference file indicating a difference between a second relational database and a first relational database, the first and second relational databases respectively having a plurality of database pages;
receiving the difference file at the navigation device, the navigation device storing a first compressed database version of the first relational database;
restoring, by the navigation device, the database pages of the second relational database from the first compressed database version and the difference file, where the restoring is performed on a page level and comprises:
reading and uncompressing a database page from the first compressed database version;
modifying the uncompressed database page in accordance with the difference file to restore a database page of the second relational database; and
compressing and appending the restored database page of the second relational database to a target database.

2. The method of claim 1, where computing the difference file comprises:
sequentially reading the database pages of the second relational database and performing a pattern scan to identify repeating data patterns.

3. The method of claim 2, where computing the difference file comprises:
reading at least one database page of the second relational database;
reading a plurality of database pages of the first relational database; and
executing a first pattern scanner to determine a data pattern in the at least one database page of the second relational database that has a matching data pattern in the plurality of database pages of the first relational database.

4. The method of claim 3, where the data pattern is a first data pattern and the matching data pattern is a first matching data pattern, and where computing the difference file further comprises:
executing a second pattern scanner to determine a second data pattern in the at least one database page of the second relational database that has a second matching data pattern in the at least one database page of the second relational database, and
in response to the first pattern scanner identifying the first matching data pattern, storing, in the difference file, a reference to the first matching data pattern in the first relational database;
in response to the second pattern scanner identifying the second matching data pattern, storing, in the difference file, a reference to the second matching data pattern in the second relational database; and
in response to neither the first pattern scanner nor the second pattern scanner identifying a match, storing the first data pattern in the difference file.

5. The method of claim 2, further comprising:
performing, by the server, an uncompression operation to retrieve the database pages of the first relational database and the database pages of the second relational database, where the difference file is computed after the uncompression operation.

6. The method of claim 1, where modifying the uncompressed database page comprises:
determining, by the navigation device, whether the difference file includes a reference to a data pattern in another database page of the first relational database; and
selectively copying, by the navigation device, the data pattern from the another database page of the first relational database to the database page of the second relational database.

7. The method of claim 1, where modifying the uncompressed database page by the navigation device comprises:
determining, in the difference file, a reference to a data pattern in another database page of the second relational database which was previously restored; and
selectively copying the previously restored data pattern from the another database page of the second relational database to the database page of the second relational database.

8. The method of claim 1, where the restoring further comprises:
persistently storing the target database after appending the database page of the second relational database to the target database;
interrupting the restoring when the navigation device enters a low power mode; and
continuing the restoring from a point of restoring not included in the persistently stored target database when the navigation device emerges from the low power mode.

9. A navigation device, comprising:
a storage device configured to store a first compressed database version of a first relational database, which comprises a plurality of database pages;
an interface configured to receive a difference file which indicates a difference between a second relational database and the first relational database; and
a processor configured to communicate with the storage device and the interface, and further configured to restore a plurality of database pages of the second relational database based on the first compressed database version and the difference file by:
the processor being configured to read and uncompress a database page from the first compressed database version;
the processor being further configured to modify the uncompressed database page in accordance with the difference file to restore a database page of the second relational database; and
the processor being further configured to compress and append the restored database page of the second relational database to a target database.

10. The navigation device of claim 9, where:
the processor is further configured to determine the difference file includes a reference to a data pattern in another database page of the first relational database; and
the processor is further configured to selectively copy the data pattern from the another database page of the first relational database to the database page of the second relational database.

11. The navigation device of claim 9, where:
the processor is further configured to determine the difference file includes a reference to a data pattern in another database page of the second relational database which was previously restored; and
the processor is further configured to selectively copy the data pattern from the previously restored another database page of the second relational database to the database page of the second relational database.

12. The navigation device of claim 9, where:
the processor is further configured to iteratively repeat a restoration procedure for a plurality of database pages of the second relational database;
the processor is further configured to persistently store the target database after each of the plurality of database pages are restored as database pages of the second relational database, and are appended to the target database;
the processor is further configured to interrupt the restoration procedure in response to the navigation device being switched to a low power mode; and
the processor is further configured to continue the interrupted restoration procedure in response to the navigation device being switched out of the low power mode.

13. The navigation device of claim 9, where the processor is configured to provide navigation information based on the first compressed database version in parallel to the restoration of the database pages of the second relational database.

14. An update server, comprising:
a storage device configured to store a first compressed database version of a first relational database and a second compressed database version of a second relational database, the first and second relational databases each having a plurality of database pages;
a processor configured to:
read and uncompress database pages from the first compressed database version to obtain the database pages of the first relational database,
read and uncompress database pages of the second compressed database version to obtain the database pages of the second relational database, and
compute a difference file which indicates a difference between the database pages of the second relational database and the database pages of the first relational database; and
an interface configured to transfer the difference file to a navigation device.

15. The update server of claim 14, where the plurality of database pages of the first relational database is a plurality of first database pages, and the plurality of database pages of the second relational database is a plurality of second database pages, the update server further comprising:
the processor configured to read at least one second database page of the second database pages;
the processor further configured to read a subset of the first database pages of the first relational database;
a first pattern scanner configured to determine a first matching data pattern in the subset of the first database pages, where the first matching data pattern corresponds to a data pattern in the at least one second database page; and
in response to the determination of the first matching data pattern by the first pattern scanner, the processor further configured to store in the difference file, a reference to the first matching data pattern in the first relational database.

16. The update server of claim 15, where the subset of first database pages includes a predetermined number of database pages from the first database pages.

17. The update server of claim 15, further comprising:
a second pattern scanner configured to determine a second matching data pattern in the at least one second database page, where the second matching data pattern corresponds to the data pattern;
in response to identification of the second matching data pattern by the second pattern scanner, the processor further configured to store in the difference file, a reference to the second matching data pattern in the second relational database.

18. The update server of claim 17, where the second pattern scanner is configured to determine the second matching data pattern in a predetermined number of second database pages preceding the at least one second database page.

19. The update server of claim 17, where absent identification of the first matching data pattern and the second matching data pattern, the processor is configured to store the data pattern in the difference file.

20. The update server of claim 14, where the processor is configured to compress the difference file before transferring it via the interface.
